(19) United States
(12) Patent Application Publication
(10) Pub. No.: US 2009/0279250 A1
(43) Pub. Date: Nov. 12, 2009

(54) DISK DRIVE BRACKET ASSEMBLY

(75) Inventor: ZHAN-YANG LI, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (SHENZHEN) CO., LTD., Shenzhen City (CN); HON HAI PRECISION INDUSTRY CO., LTD., Tu-Cheng (TW)

(21) Appl. No.: 12/208,637

(22) Filed: Sep. 11, 2008

(30) Foreign Application Priority Data
May 7, 2008 (CN) 200820300685.1

(51) Int. Cl. G06F 1/16

(52) U.S. Cl. 361/679.58

(57) ABSTRACT

A disk drive bracket assembly includes a bracket capable of receiving at least one disk drive therein, along with a shielding member. The bracket includes a pair of side plates, wherein each of the side plates defines a guide slot therein. The guide slot has an entrance. The shielding member includes a front panel and a pair of side panels bent from opposite edges of the front panel. A resilient catch piece is formed on each side panel. An inclined portion is formed on the resilient catch piece and inserted into the entrance of the guide slot when the catch piece is resiliently deformed, and blocks the shielding member from separating from bracket when the inclined portion engages with an edge of the entrance.

### BACKGROUND

1. Technical Field

The present disclosure relates to disk drive bracket assemblies and, particularly, to a disk drive bracket assembly including a bracket and a shielding member secured on the bracket.

2. Description of the Related Art

A disk drive bracket assembly usually includes a bracket and a plurality of shielding members. The bracket is configured for securing a plurality of disk drives therein. When the disk drives are not secured in the bracket, shielding members are often installed in the bracket to shield the empty space of the bracket where the disk drives would be installed. To install the shielding member on the bracket, the disk drive bracket usually includes a mounting apparatus. For one example, the mounting apparatus includes two pairs of latch members pivotably secured on the chassis by screws. After the shielding member has been located on the bracket, the latch members are respectively pivoted to engage with the shielding member to firmly secure the shielding member on the bracket. As described above, the mounting apparatus is convenient to secure the shielding member on the bracket. However, this type of mounting apparatus complicates the structures disk drive bracket assembly.

Therefore, there is room for improvement within the art.

### BRIEF DESCRIPTION OF THE DRAWINGS

FIG. 1 is an exploded, isometric view of an exemplary embodiment of a disk drive bracket assembly, the assembly including a bracket and a shielding member;

FIG. 2 is an isometric view of the shielding member of FIG. 1;

FIG. 3 is an assembled view of FIG. 1; and

FIG. 4 is similar to FIG. 3, but viewed from another perspective.

### DETAILED DESCRIPTION OF THE EMBODIMENTS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

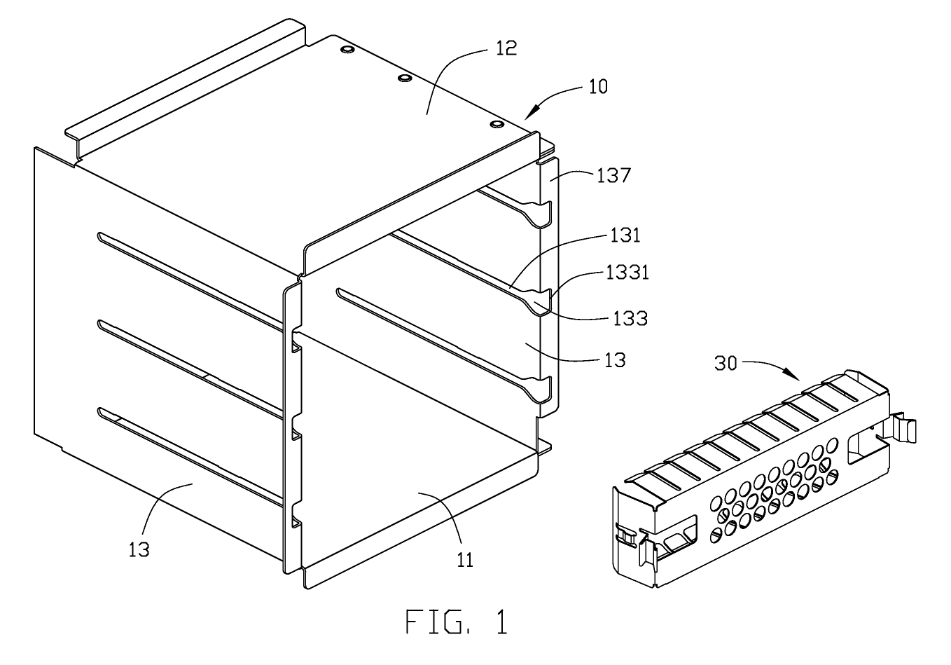

Referring to FIG. 1, a bracket assembly of an exemplary embodiment of the present disclosure includes a bracket 10 configured for receiving a plurality of disk drives (not shown) therein, and a shielding member 30 removably attachable to the bracket 10.

The bracket 10 includes a bottom plate 11, a top plate 12 parallel to the bottom plate 11, and a pair of parallel side plates 13 perpendicular to the bottom plate 11 and the top plate 12. A bent flange 137 is bent out from and generally perpendicular to a front edge of each side plate 13. Each side plate 13 and corresponding bent flange 137 defines a plurality of guide slots 131 extending generally parallel to the bottom plate 11. Each guide slots 131 has an entrance 133 at a front end thereof and defined by bent flange 137. Each entrance 133 has an edge 1331 generally perpendicular to the bottom plate 11.

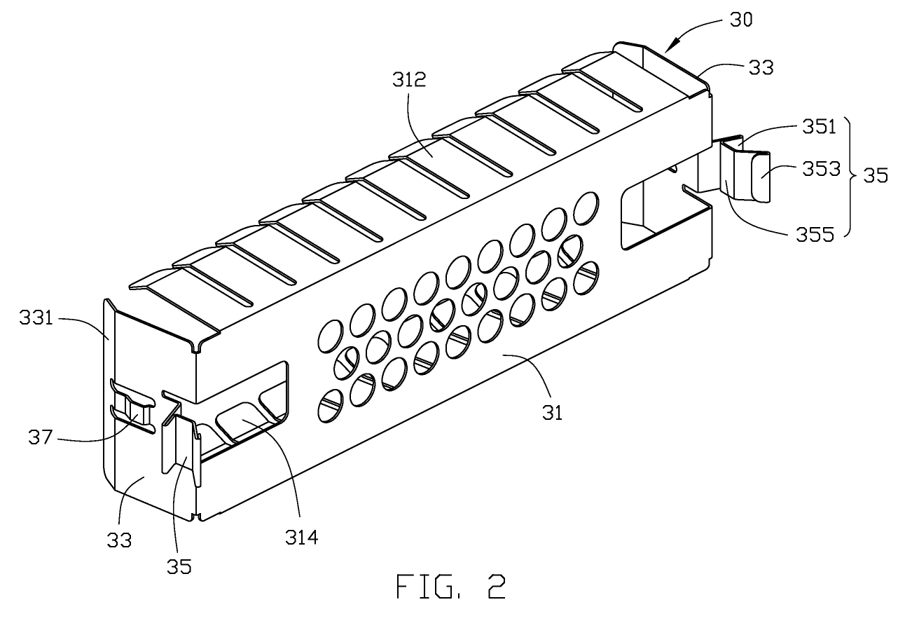

Referring to FIG. 2, the shielding member 30 includes a front panel 31, and a pair of side panels 33 generally perpendicular to and bent in from the side edges of the front panel 31. A guide flange 331 is bent in from a rear edge of each side panel 33. A position protrusion 37 projects from each side panel 33 for engaging in the guide slot 131 of the bracket 10. A resilient catch piece 35 is formed on each side panel 33. Each catch piece 35 includes an inclined portion 351 connected to the side panel 33, an operating portion 33, and a connecting portion 355 connecting with the inclined portion 351 and the operating portion 353. Resilient finger clips 312, 314 respectively extend from a top edge and a bottom edge of the front panel 31.

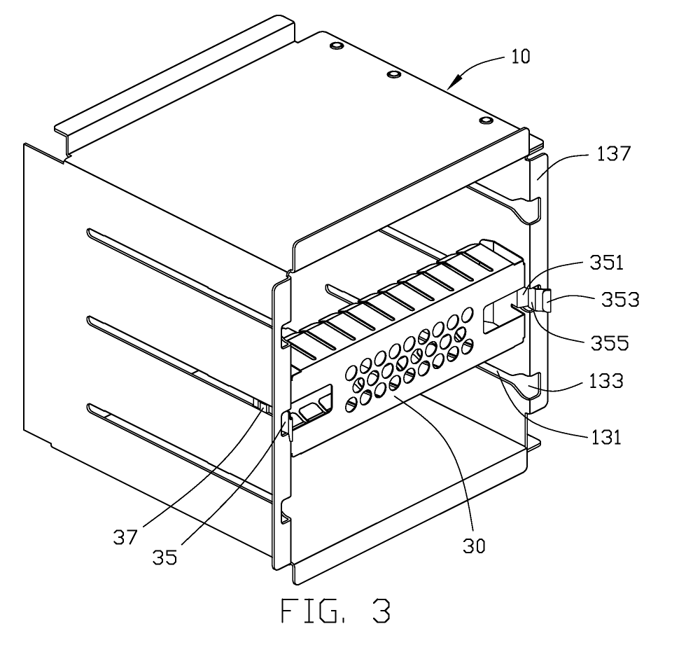

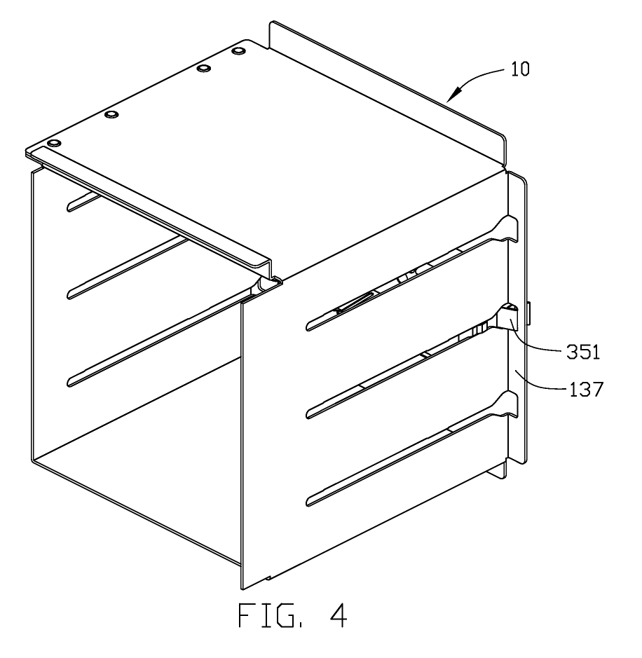

Referring also to FIGS. 3 and 4, in assembling the shielding member 30 to the bracket 10, the side panels 33 of the shielding member 30 are inserted between the side plates 13 of the bracket 10 until the guide flanges 331 abut the front edges of the side plates 13, and the protrusions 37 of the shielding member 30 align with corresponding guide slots 131 of the side plates 13. Then, the shielding member 30 is pushed further into the bracket 10. The guide flanges 331 are pressed by the front edges of the side plates 13 to resiliently deform the side plates 33 and allow easy insertion of shielding member 30 into the bracket 10. The positioning protrusions 37 are inserted into the guide slots 131 via the entrances 133 until the inclined portions 351 of the catch pieces 35 abut the edges 1331 of the entrances 133. The shielding member 30 is yet further pushed into the bracket 10. The inclined portions 351 are pressed by the edges of the entrances 133 to resiliently deform catch pieces 35. When the inclined portions 351 pass across the edges of the entrances 133, the catch pieces 35 rebound to have the edges 1331 of the entrances 133 positioned between the inclined portions 351 and the operating portions 353. The inclined portions 351 of the shielding member 30 are blocked by the bent flanges 137 of the side plates 13 from separating from bracket 10. Thus, the shielding member 30 is firmly secured in the bracket 10.

In disassembling the shielding members 10 from the bracket 10, the operating portions 353 of their catch pieces 35 are pressed towards each other to resiliently deform the catch piece, thereby disengaging the edges entries 133 from the catch pieces 35 allow the shielding member 30 to be removed from the bracket 10.

In this exemplary embodiment, the finger clips 312, 314 of the front panel are capable of electrically connecting with disk drives when the disk drives are secured into the bracket 10.

It is to be understood, however, that even though numerous characteristics and advantages have been set forth in the foregoing present disclosure, together with details of the structures and functions of the present disclosure, the disclosure is illustrative only, and changes may be made in detail, especially in matters of shape, size, and arrangement of parts within the principles of the present disclosure to the full extent indicated by the broad general meaning of the terms in which the appended claims are expressed.

1. A disk drive bracket assembly, comprising:
a bracket capable of receiving at least one disk drive therein, the bracket comprising a pair of side plates, a bent flange bent from each side plate, each side plate and corresponding bent flange defining a guide slot; and
a shielding member comprising a front panel and a pair of side panels extending perpendicularly from opposite edges of the front panel towards a rear side of the front panel, a protrusion and a resilient catch piece extending from each side panel toward a front side of the front panel, wherein the protrusions are engagable in corresponding guide slots, and the catch pieces are removably engagable with corresponding bent flanges to secure the shielding member between the side plates of the bracket.

2. The disk drive bracket assembly of claim 1, wherein the protrusions are slidable in corresponding guide slots until the catch pieces engage with corresponding bent flanges.

3. The disk drive bracket assembly of claim 1, wherein the catch pieces are resiliently deformed opposite to each other when disengaging from corresponding bent flanges.

4. The disk drive bracket assembly of claim 1, wherein a guide flange is bent from each side panel, and capable of deforming the side panels when the shielding member is inserted into the bracket.

5. The disk drive bracket assembly of claim 1, wherein each catch piece of the shielding member comprises an inclined portion, the inclined portion is pressed by corresponding bent flange to resiliently deform corresponding catch piece when the shielding member is inserted in the bracket, and prevents the shielding member from separating from the bracket when the catch pieces rebound to engage the inclined portion with corresponding bent flange.

6. The disk drive bracket assembly of claim 5, wherein each catch piece further comprises an operating portion and a connecting portion connected between the inclined portion and the operating portion, and the operating portion is capable of deforming the catch piece to disengage the catch piece from corresponding bent flange.

7. The disk drive bracket assembly of claim 6, wherein the bent flange of each side plate is positioned between the inclined portion and the operating portion of corresponding catch piece when corresponding catch piece engages with the bent flange.

8. The disk drive bracket assembly of claim 7, wherein each guide slot has an entrance defined in each side plate and corresponding bent flange, and edges of the entrance blocks the inclined portion from further inserting into the guiding slot beyond the entrance when corresponding catch pieces engages with corresponding bent flanges.

9. A disk drive bracket assembly, comprising:
a bracket capable of receiving at least one disk drive therein, the bracket comprising a pair of side plates, each side plate defining a guide slot having an entrance; and
a shielding member comprising a front panel, two rows of resilient finger clips extending respectively from a top edge and a bottom edge of the front panel, and a pair of side panels bent from opposite edges of the front panel, a resilient catch piece formed on each side panel, an inclined portion formed on the resilient catch piece and inserted into the entrance when the catch piece is resiliently deformed, and preventing the shielding member from separating from the bracket when the inclined portion engages with an edge of the entrance.

10. The disk drive bracket assembly of claim 9, wherein an operating portion and a connecting portion are formed on each catch piece, the connecting portion between the inclined portion and the operating portion, and the operating portion is capable of resiliently deforming the catch piece.

11. The disk drive bracket assembly of claim 10, wherein a bent flange is formed on each side plate, and the bent flange is positioned between the inclined portion and the operating portion when corresponding catch piece engages the bent flange.

12. The disk drive bracket assembly of claim 9, wherein a guide flange is bent from each side panel, and capable of deforming the side panels shielding member when the shielding member is inserted into the bracket.

13. The disk drive bracket assembly of claim 9, wherein a protrusion is formed on each side panel of the shielding member, and capable of sliding in corresponding guide slot of the bracket.

14. The disk drive bracket assembly of claim 9, wherein the bracket further comprises a bottom plate perpendicular to the side plates, and the edge of the entry is perpendicular to the bottom plate.
